(19) United States
(12) Patent Application Publication
(10) Pub. No.: US 2007/0177025 A1
(43) Pub. Date: Aug. 2, 2007

(54) Method and apparatus minimizing die area and module size for a dual-camera mobile device

(75) Inventors: Thomas G. Kopet, San Jose, CA (US); Martin J. Agan, Pasadena, CA (US)

Correspondence Address: DICKSTEIN SHAPIRO LLP, 1825 EYE STREET NW, Washington, DC, 20006-5403, US

(73) Assignee: MICRON TECHNOLOGY, INC.

(21) Appl. No.: 11/344,183

(22) Filed: Feb. 1, 2006

(51) Int. Cl. H04N 5/228

(52) U.S. Cl. 348/222.1

(57) ABSTRACT

A mobile device including a first image sensor, an image processor coupled to and residing on the same integrated circuit as the first image sensor, and a second image sensor, wherein the image processor is configured to substantially and separately process images from the first and second image sensors.

### FIELD OF THE INVENTION

The invention relates generally to a mobile imaging device comprising at least two integrated cameras.

### BACKGROUND OF THE INVENTION

Dual-camera mobile devices, such as mobile telephones (also called mobile phones and cell phones), are known in the art and increasing in popularity. One camera functions as a still image camera, and the other as a video camera. The video camera is used for video conferencing applications, and would typically face the user during operation. The still image camera may be used for taking still images at typically higher resolution than the video camera. Many implementations use a separate processor for each camera, which have the disadvantage of requiring additional system cost and greater area/volume within the mobile device (i.e. mobile telephones).

Solid state imaging devices having pixel arrays, including charge coupled imaging devices (CCD) and complementary metal oxide semiconductor (CMOS) imaging devices, and other solid state imaging devices are commonly used in photo-imaging applications, such as the cameras described above.

One implementation of a dual-camera single-processor mobile telephone is discussed in U.S. Patent Application No. 2005/0036046 to Atsum, filed Feb. 17, 2005 (hereinafter “Atsum”). In Atsum, two cameras are connected to a single processor, but the images are taken contemporaneously, and the processing of the two images is interleaved in the processor by breaking down each image into “stripes” and alternately processing one stripe at a time from each image. The disadvantage of this type of processing is that it requires additional processing and decoding to separate and identify the different images. Atsum requires an additional file to be created to identify how large each “stripe” of data will be, as well as an additional steps of compressing the data, and then uncompressing the data before processing. The encoder and decoder of the Atsum device adds to the complexity, size, and cost of the mobile telephone.

As dual-camera mobile devices, such as telephones, increase in their popularity there is an obvious need and desire for simplified system solutions that reduce system cost and minimize the area/volume occupied by such a dual-camera solution within the mobile device.

### BRIEF SUMMARY OF THE INVENTION

In accordance with exemplary embodiments of the invention, a method and implementing apparatus minimizing die area and module size for a dual-camera mobile device includes a first image sensor, an image processor coupled to and residing on the same integrated circuit as the first image sensor, and a second image sensor, wherein the image processor is configured to substantially and separately process images from the first and second image sensors.

### BRIEF DESCRIPTION OF THE DRAWINGS

The foregoing and other advantages and features of the invention will be more readily understood from the following detailed description of the invention provided below with reference to the accompanying drawing, in which:

FIG. 1 illustrates a block diagram of a mobile device in accordance with the invention; and

FIG. 2 illustrates a flowchart of a processing of images in accordance with the invention.

### DETAILED DESCRIPTION OF THE INVENTION

In the following detailed description, reference is made to the accompanying drawings, which form a part hereof and show by way of illustration specific embodiments in which the invention may be practiced. These embodiments are described in sufficient detail to enable those skilled in the art to practice the invention, and it is to be understood that other embodiments may be utilized, and that structural, logical, and electrical changes may be made without departing from the spirit and scope of the present invention. The progression of processing steps described is exemplary of the embodiments of the invention; however, the sequence of steps is not limited to that set forth herein and may be changed as is known in the art, with the exception of steps necessarily occurring in a certain order.

In a dual-camera telephone implementation in accordance with the invention, only one camera needs to operate at a time. Since the image processing is similar for both camera image sensors, the image processing can be shared. This sharing is accomplished by using a first sensor having associated on-chip processing and a second sensor which does not have associated on-chip processing. Image data from the second camera is bridged via a serial or parallel interface to the first camera, which performs the processing for the second sensor.

The mobile device of the invention minimizes system cost by eliminating the replication of on-chip image processing or complicated simultaneous processing of images from two sensors. In a typical dual-camera telephone there are two on-chip processors, each of which contains the full suite of image processing algorithms to translate the raw, e.g. Bayer pattern output of the sensor, into, e.g., a quality luminance/chrominance (YUV) or a compressed image data output. In the proposed solution the on-chip processing is only present for the first sensor's chip but this processing is also selectively usable by the second sensor. This results in a die area savings for a two-sensor mobile device.

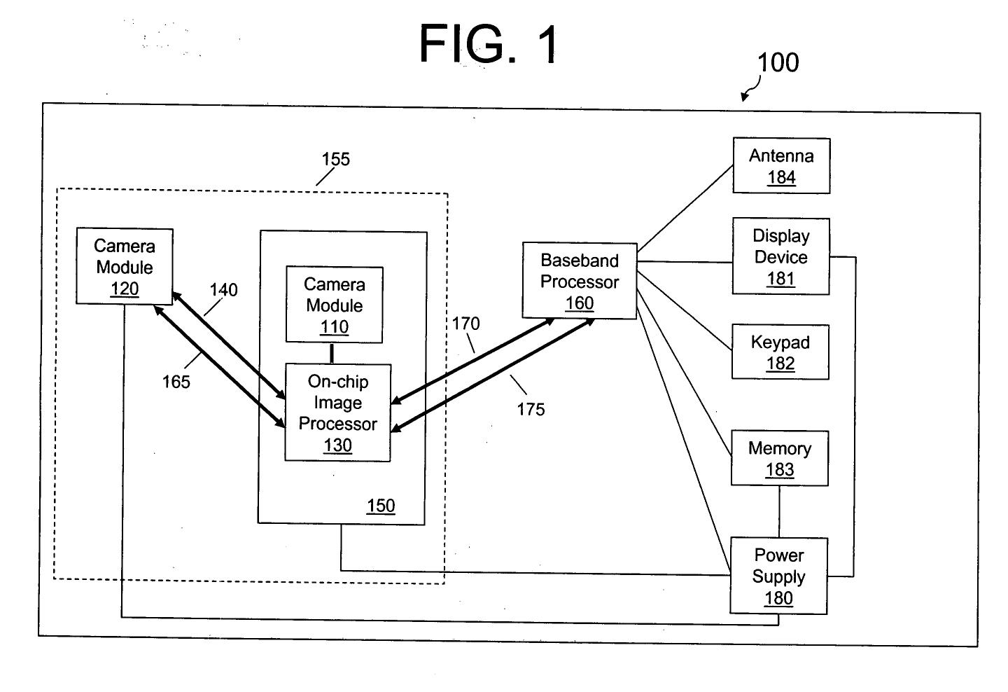

FIG. 1 illustrates a block diagram of an exemplary embodiment of mobile device 100 constructed in accordance with the invention. Mobile device 100 comprises first camera module 110, second camera module 120, on-chip image processor 130, which is integrated on the same chip as camera module 110, bridge interface 140, and baseband processor 160. The first and second camera modules 110, 120, on-chip image processor 130, and bridge interface 140 form a dual-camera unit 155 constructed according to the invention. Mobile device 100 also includes a power supply 180 (e.g. battery), display device 181, and, for telephone applications, a keypad 182, memory 183, and an antenna 184. Dimensional and spatial aspects of components illustrated in FIG. 1 are not intended to be limiting.

First camera module 110 is directed toward the back of mobile device 100, and may be used as a still image or video camera. First camera module 110 may typically range from 1.3 megapixels to 5 megapixels in resolution, although both higher and lower resolutions may be used to practice the invention. First camera module 110 is formed on chip 150. On-chip image processor 130 is also formed on chip 150. On-chip image processor 130 performs the requisite image and other processing on the image data stream from first camera 110.

Second camera module 120 is directed toward the front of mobile device 100, typically facing the user, and may be used as a video or still image camera. In a desired application, the second camera module 120 may be used for video conferencing. Second camera module 120 may be optimized for video conferencing applications by maximizing the low light performance of the module 120. VGA is typically the maximum resolution required to use second camera module 120 for video conferencing applications, although the invention is not intended to be limited to VGA output. Second camera module 120 is connected to on-chip image processor 130 via bridge interface 140, which may be either a serial or parallel connection, although other connections may also be used. On-chip image processor 130 also includes control mechanisms to receive pixel data from the second camera module 120 and to perform the requisite processing on the image data stream from second camera module 120.

On-chip image processor 130 typically controls the second camera module 120 using an optional bidirectional serial control interface 165. However, when bridge interface 140 is a high-speed serial interface, mobile device 100 may also use bridge interface 140 to control the second camera module 120, provided the bridge interface 140 supports bidirectional data transfers, in which case optional bidirectional serial control interface 165 would be unnecessary. The on-chip image processor 130 may output via a data interface 170 to the mobile device baseband processor 160 a processed image from first camera module 110 or the processed image or image stream relayed and processed from second camera module 120.

Baseband processor 160 is a communications control processor for a mobile device which performs the general functions of mobile device 100. For example, if mobile device 100 is a mobile telephone, baseband processor 160 may generate the display, process incoming and outgoing calls, maintain an address book, and other associated functions. Functions such as focus, zoom, and white balancing for camera modules 110, 120 may be controlled by baseband processor 160 or on-chip image processor 130, depending on the phone architecture.

For increased flexibility, the on-chip image processor 130 may be equipped with both high-speed serial and parallel interfaces such that if bridge interface 140 is a parallel interface, then data interface 170 is a high-speed serial interface, or vice versa. However, a preset serial or parallel interface for bridge interface 140 or data interface 170 may also be used.

Since camera module 120 does not need an associated processor, it has a much smaller size than chip 150, which comprises camera module 110 and associated on-chip image processor 130. For some flip-type mobile telephone applications this has the benefit of requiring fewer interface wires to run through the phone hinge, simplifying the flex cable and reducing electromagnetic interference. The interface of baseband processor 160 to the dual-camera unit 155 may be simplified by having only one interface that receives image data from the two cameras. This would also reduce the cost of baseband processor 160.

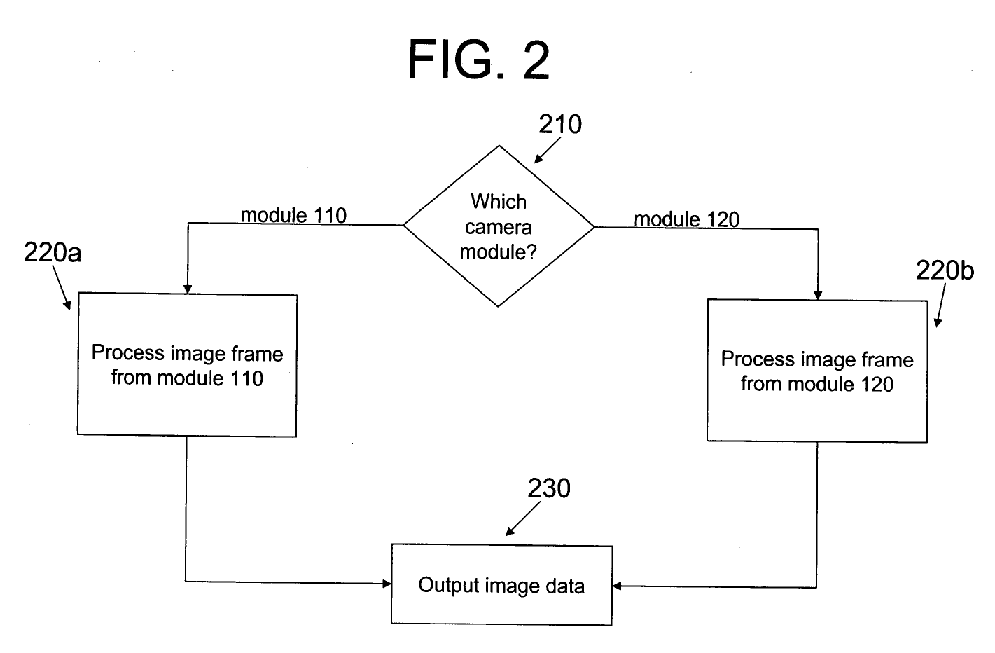

FIG. 2 is a flowchart showing how on-chip image processor 130 processes images from first and second camera modules 110, 120. At step 210, on-chip image processor 130 identifies which camera module 110, 120 sent an image to be processed. This can be recognized from a user selection made at keypad 182, which is communicated to on-chip image processor 130 from baseband processor 160, which also causes on-chip image processor 130 to couple to a selected one of the first and second camera modules 110, 120. Next, at step 220a, 220b, on-chip image processor 130 processes the appropriate image frame from the data sent from the selected camera module 110 or 120. Then, at step 230, the processed image frame is sent to baseband processor 160. Therefore, on-chip image processor 130 processes images from a selected first or second camera module 110, 120, and switches to process images from the non-selected image camera module 120, 110 when the non-selected camera module 120, 110 is selected for operation.

The invention further includes methods of forming and operating a multi-camera unit of the embodiment illustrated in the figures. The method of operating the dual-camera unit 155 for a mobile device 100 comprises acquiring a first image with a first image sensor 110, processing the first image with an image processor 130 residing on the same integrated circuit 150 as said first image sensor 110. The method further comprises acquiring a second image with a second image sensor 120, transmitting the second image to the image processor 130 over a bridge interface 140, and processing the second image with the processor 130. The method may further include sending the processed image from on-chip image processor 130 to baseband processor 160 for handling in accordance with a user preference, entered at keypad 182.

The method of forming the multi-camera unit 155 comprises providing a first image sensor 110, providing an image processor 130 connected to and residing on the same integrated circuit 150 as the first image sensor 110 for processing images, pro viding a bridge interface 140 connected to the image processor 130, and providing a second image sensor 120 connected to the bridge interface 140. The second image sensor 120 outputs images to the processor 130 over the bridge interface 140. The image processor 130 is configured to substantially and separately process images from the first and second image sensors 110, 120.

While the invention has been described in detail in connection with exemplary embodiments known at the time, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. For example, the mobile device 100 may be a personal digital assistant (PDA), mobile telephone, e-mail device, or other mobile communication device, and the camera modules 110, 120 are not limited to a still and a video camera. Non-limiting examples of camera modules 110, 120 usable in accordance with the invention are, respectively, Micron Part Nos. MI-SOC3130 and MI-380. In addition, the invention is not limited to the type of connections presented in the description of bridge interface 140.

Thus, the invention is not to be seen as limited by the foregoing description, but is only limited by the scope of the appended claims.

What is claimed as new and desired to be protected by Letters Patent of the United States is:

1. A multi-camera unit comprising:
a first image sensor;
an image processor coupled to and residing on a same integrated circuit as said first image sensor; and
a second image sensor,
wherein said image processor is configured to substantially and separately process images from said first and second image sensors.

2. The multi-camera unit of claim 1, wherein said first image sensor comprises one of a still camera and a video camera.

3. The multi-camera unit of claim 2, wherein said second image sensor comprises one of a still camera and a video camera.

4. The multi-camera unit of claim 3, wherein:
said first image sensor comprises a still camera; and
said second image sensor comprises a video camera.

5. The multi-camera unit of claim 4, further comprising:
a bridge interface coupled to said image processor,
wherein said second image sensor is coupled to said bridge interface, said second image sensor outputting images to said processor over said bridge interface.

6. The multi-camera unit of claim 5, wherein said multi-camera unit comprises a mobile communication device.

7. The multi-camera unit of claim 6, wherein said mobile communication device comprises a mobile telephone.

8. The multi-camera unit of claim 6, wherein said mobile communication device comprises a personal digital assistant.

9. The multi-camera unit of claim 6, wherein said mobile communication device comprises an e-mail device.

10. The multi-camera unit of claim 5, wherein said image processor processes images from a selected first or second image sensor and switches to process images from a non-selected second or first image sensor when said non-selected second or first image sensor is selected for operation.

11. A mobile communication device comprising:
at least one communications processor for controlling communications operations of said mobile communication device;
a first image sensor;
a second image sensor; and
an image processor coupled to and residing on a same integrated circuit as said first image sensor, and operable to selectively separately process images from said first and second image sensors and supply a processed image for said communication processor.

12. The mobile communication device of claim 11, wherein said first image sensor comprises one of a still camera and a video camera.

13. The mobile communication device of claim 12, wherein said second image sensor comprises one of a still camera and a video camera.

14. The mobile communication device of claim 13, wherein:
said first image sensor comprises a still camera, and
said second image sensor comprises a video camera.

15. The mobile communication device of claim 14, further comprising:
a bridge interface coupled to said image processor,
wherein said second image sensor is coupled to said bridge interface, said second image sensor outputting images to said processor over said bridge interface.

16. The mobile communication device of claim 15, wherein said mobile communication device comprises a mobile telephone.

17. The mobile communication device of claim 16, wherein said mobile communication device comprises a personal digital assistant.

18. The mobile communication device of claim 16, wherein said mobile communication device comprises an e-mail device.

19. The mobile communication device of claim 15, wherein said image processor processes images from a selected first or second image sensor and switches to process images from a non-selected second or first image sensor when said non-selected second or first image sensor is selected for operation.

20. The mobile communication device of claim 15, further comprising:
a data interface coupled to said image processor and to at least one communications processor.

21. The mobile communication device of claim 20, wherein said bridge interface comprises a parallel interface.

22. The mobile communication device of claim 20, wherein said data interface comprises a parallel interface.

23. A method of operating a dual-camera unit for a mobile device comprising:
acquiring a first image with a first image sensor;
processing said first image with an image processor residing on a same integrated circuit as said first image sensor;
acquiring a second image with a second image sensor; and
processing said second image with said processor.

24. The method of claim 23, wherein said first image sensor operates as one of a still camera and a video camera.

25. The method of claim 24, wherein said second image sensor operates as one of a still camera and a video camera.

26. The method of claim 25, wherein:
said first image sensor operates as a still camera, and
said second image sensor operates as a video camera.

27. The method of claim 26, wherein:
said second image sensor outputs images to said processor over a bridge interface.

28. The method of claim 27, wherein said image processor processes images from a selected first or second image sensor and switches to process images from a non-selected second or first image sensor when said non-selected second or first image sensor is selected for operation.

29. A method of forming a multi-camera unit comprising:
providing a first image sensor;
providing an image processor coupled to and residing on a same integrated circuit as said first image sensor; and
providing a second image sensor,
wherein said image processor is configured to substantially and separately process images from said first and second image sensors.

30. The method of claim 29, wherein said step of providing said first image sensor comprises providing one of a still camera and a video camera.

31. The method of claim 30, wherein said step of providing said second image sensor comprises providing one of a still camera and a video camera.

32. The method of claim 31, wherein:
said step of providing said first image sensor comprises providing a still camera, and
said step of providing said second image sensor comprises providing a video camera.

33. The method of claim 32, further comprising:
providing a bridge interface coupled to said image processor,
wherein said second image sensor is coupled to said bridge interface, said second image sensor outputting images to said processor over said bridge interface.

34. The method of claim 33, wherein said image processor is provided to process images from a selected first or second image sensor and to switch to process images from a non-selected second or first image sensor when said non-selected second or first image sensor is selected for operation.
